(19) United States
(12) Patent Application Publication
(10) Pub. No.: US 2025/0176452 A1
(43) Pub. Date: Jun. 5, 2025

(54) Method for operating a towed agricultural work implement and towed agricultural work implement

(71) Applicant: Amazonen-Werke H. Dreyer SE & CO. KG, Hasbergen (DE)

(72) Inventor: Daniel MERTENS, Oldenburg (DE)

(73) Assignee: Amazonen-Werke H. Dreyer SE & CO. KG, Hasbergen (DE)

(21) Appl. No.: 18/727,497

(22) PCT Filed: Jan. 10, 2023
(86) PCT No.: PCT/EP2023/050362

§ 371 Date: Jul. 9, 2024

(30) Foreign Application Priority Data
Jan. 19, 2022 (DE) 10 2022 101 172.0

(51) Int. Cl. A01B 69/00

(52) U.S. Cl. CPC A01B 69/003

(57) ABSTRACT

The disclosure relates to a method for operating a towed agricultural work implement (10) comprising a boom, in particular a seed drill or cultivator, comprising at least one support wheel for supporting the boom on the ground, wherein the at least one support wheel is actively controlled. The disclosure also relates to a towed agricultural work implement for carrying out this method.

The present application claims priority under 35 U.S.C. § 119 to German Application No. 10 2022 101 172.0 filed on Jan. 19, 2022, and under 35 U.S.C. § 365 to International Application No. PCT/EP2023/050362 filed on Jan. 10, 2023. The entire contents of these applications are incorporated herein by reference in their entirety.

### BACKGROUND

The disclosure relates to a method for operating a towed agricultural work implement. Furthermore, the disclosure relates to a towed agricultural work implement.

Depending on the intended use, different agricultural work implements are used for soil cultivation. Towed agricultural work implements are moved over the ground using a tractor.

In order to support the work implement on the ground, such as the soil or earth in particular, at least one support wheel is provided. This runs over the ground or soil. The at least one support wheel is used to guide the work implement at the set height above the ground. Furthermore, the drawbar load on the tractor is reduced.

In order to enable cornering, trailing support wheels are known from the prior art. This is achieved by a support wheel holder with a vertical pivot axis. In this case, the rotation axis of the support wheel is arranged spaced apart from the pivot axis. This allows the support wheel to follow the movement of the work implement.

However, the disadvantage of the known trailing support wheels is that this only works reliably on large curve radii and when the direction of travel is maintained. In the case of tight curves, turning maneuvers or even reversing, the support wheels practically pivot around on the spot. This leads to compaction and, in particular, lateral displacement of the earth. When reversing, the support wheels may therefore have to be locked to prevent them from pivoting.

### SUMMARY

It is therefore an object of the disclosure to overcome these disadvantages. In particular, compaction and earthmoving as well as additional effort when reversing should be avoided as far as possible.

This problem is solved by a method for operating a towed agricultural work implement having the features of claim 1. The towed agricultural work implement comprises a boom, wherein it can in particular be a seed drill or a cultivator. The work implement is equipped with at least one support wheel for supporting the boom on a ground, in particular earth. The work implement is characterized in that the at least one support wheel is actively controlled. In particular, this means that the at least one support wheel has a defined alignment or position. In contrast, in the prior art, the alignment or position is determined by pivoting due to the effect of the ground. This allows the alignment or position of the at least one support wheel to be controlled to match the movement of the work implement. In particular, the direction of rotation of the support wheel can be set to match the direction of movement of the work implement.

Preferably, at least one axis of the at least one support wheel is driven. The axis is preferably a rotation axis and/or a pivot axis and/or a tilting axis. In this way, the alignment and/or position of the support wheel can be influenced in one or more directions, in particular actively.

At least one drive unit, preferably a motorized drive, is assigned to the at least one support wheel, preferably to at least one or each of the axes of the support wheel. In particular, one output drive is provided for each axis. In this way, it can be achieved that the individual axes and/or directions and thus the alignment and/or position of the support wheel can be adjusted and/or controlled independently of one another.

The alignment and/or position and/or height of the at least one support wheel is preferably set relative to the work implement. Setting is further preferably carried out in relation to the work implement. However, the effects of the setting ultimately come into play relative to the ground. The work implement supported by the support wheels is carried at a corresponding height above the ground. The support wheel is preferably pivoted about a pivot axis, in particular a vertical one, in particular to adapt to the movement of the work implement relative to the ground. The pivot axis should preferably be the primarily decisive axis for achieving the advantages according to the disclosure, in particular with regard to adapting the direction of rotation to the movements of the work implement.

The at least one support wheel is preferably rotationally driven. The rotational speed of the at least one support wheel around its rotation axis can be controlled. This is done in particular to adapt to the movement relative to the ground. For this purpose, a drive may be required in each case. The active adjustment of the rotational speed also improves the running properties of the at least one support wheel and thus of the work implement.

Preferably, the at least one axis of the at least one support wheel, preferably each of the axes, is driven. For this purpose, at least one motorized drive is used in particular. In this way, a targeted drive of the support wheel is made possible. This allows the support wheel to be driven so as to match the movement of the work implement, that is, in particular at the appropriate speed with respect to the ground.

The at least one support wheel is preferably steered and/or driven by a motor. In particular, at least one control unit is provided for controlling the drive. This enables automated operation. In contrast, in the prior art, only trailing of the at least one support wheel is provided. In addition, the previously known work implements require manual setting of the at least one support wheel.

In particular, the current movement state of the work implement and/or a tractor for the drive of the at least one axis of the support wheel is/are taken into account. Past movements are preferably taken into account. In particular, movements predicted for the future can also be taken into account. Preferably, curve radii can be used. In particular, the further course of the travel is/will be predicted on the basis of data of typical travel courses and/or position data (GPS) and/or data determined by means of at least one sensor. Preferably, expected future movement states and/or suitable positions of the at least one support wheel are predicted.

The problem formulated above is also solved by a towed agricultural work implement with the features of claim 9. The work implement is, for example, a seed drill or a cultivator. It comprises a boom with a support beam and at least one support wheel for support on a ground. The work implement is characterized in that an active control is provided for the at least one support wheel. In this way, it can be achieved in particular that the at least one support wheel is aligned at least almost at all times to match the movement of the work implement over the ground. In particular, in this way, it is no longer necessary to lock the alignment of the support wheel when reversing.

The support wheel and/or its connection to the boom or support beam comprises in particular at least one driven axis. This is preferably a rotation axis and/or a pivot axis and/or a tilting axis. By means of the at least one axis, an adjustment of the alignment of the at least one support wheel for the movement of the work implement can be ensured.

Preferably, at least one motorized drive is provided for the at least one axis. In particular, this is an electromotive and/or pneumatic and/or hydraulic drive. Preferably, at least one motorized drive is provided for aligning and/or rotating the support wheel. Motorized drives are suitable for automatic operation instead of the known manual operation.

A control system is preferably provided for the motorized drive of the at least one axis of the support wheel. Further preferably, at least one sensor is provided for determining the current state of movement and/or for predicting expected future states of movement. In particular, the current and/or expected future curve radius is determined, which preferably results in the appropriate position of the at least one support wheel. Such data sources are particularly suitable for the control system of the at least one support wheel.

Preferably, at least one sensor is provided for determining the actual position of the at least one support wheel. This is preferably used to be able to control the actual position of the at least one support wheel. In this way, it is possible to measure the actual alignment of the support wheel.

Alignment control is made possible instead of a simple control system. For this purpose, the measured values can be compared with the intended values for the alignment of the at least one support wheel.

Control signals for the at least one support wheel can preferably be determined using movement data from a towing vehicle. In particular, a coupling of the control system of the at least one support wheel with a control system of a towing vehicle is provided. In this way, movement data of the towing vehicle can be used to suitably control the at least one support wheel of the work implement.

Furthermore, an in particular motorized height adjustment of the at least one support wheel is preferably provided. This means that the height adjustment can also be carried out automatically, that is, in particular without manual intervention by a person. This is different from what is provided in the prior art and is preferred.

A preferred embodiment of the disclosure is described in more detail below with reference to the drawings. Therein:

### BRIEF DESCRIPTION OF THE DRAWINGS

FIG. 1 shows a perspective view of a work implement according to the disclosure towed by a tractor,

FIG. 2 shows a top view of the work implement according to the embodiment of FIG. 1, and

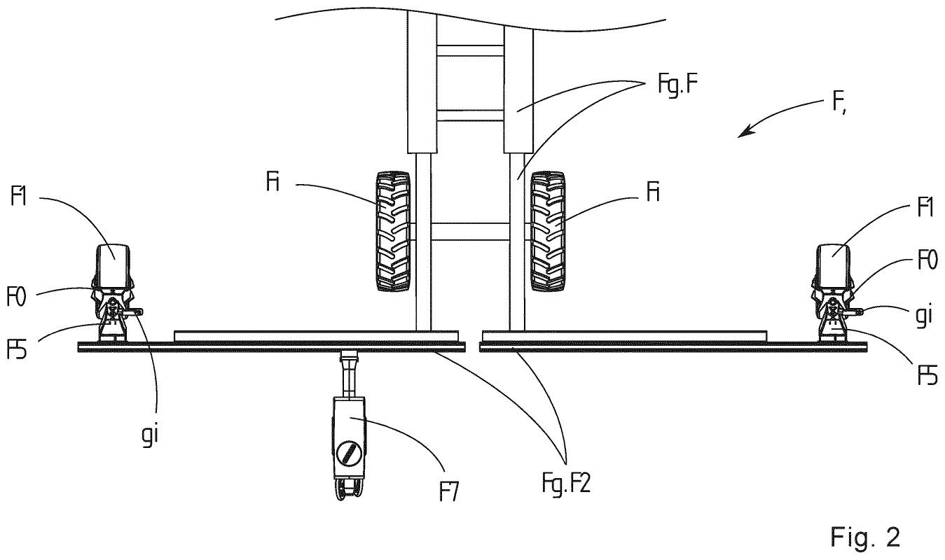

FIG. 3 shows a detailed view of a support wheel of the work implement according to the disclosure.

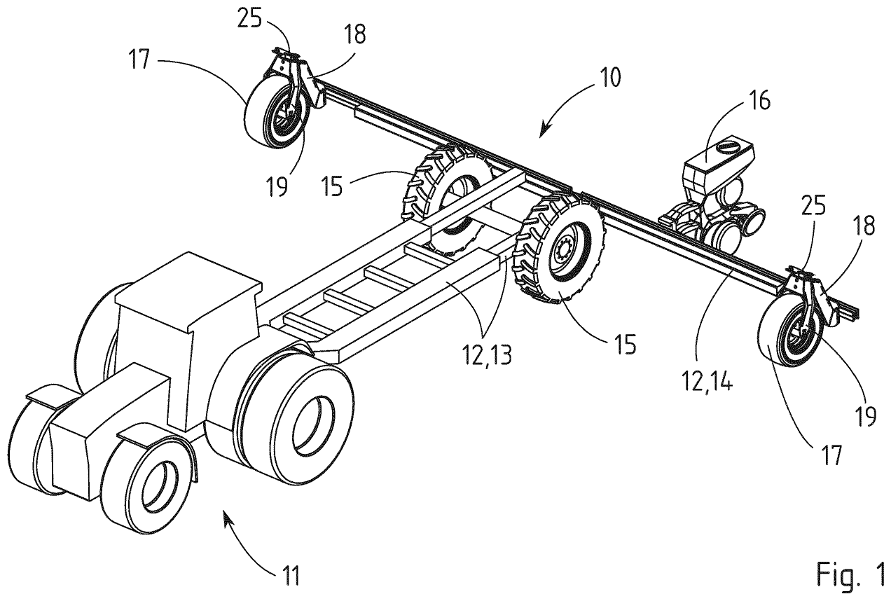

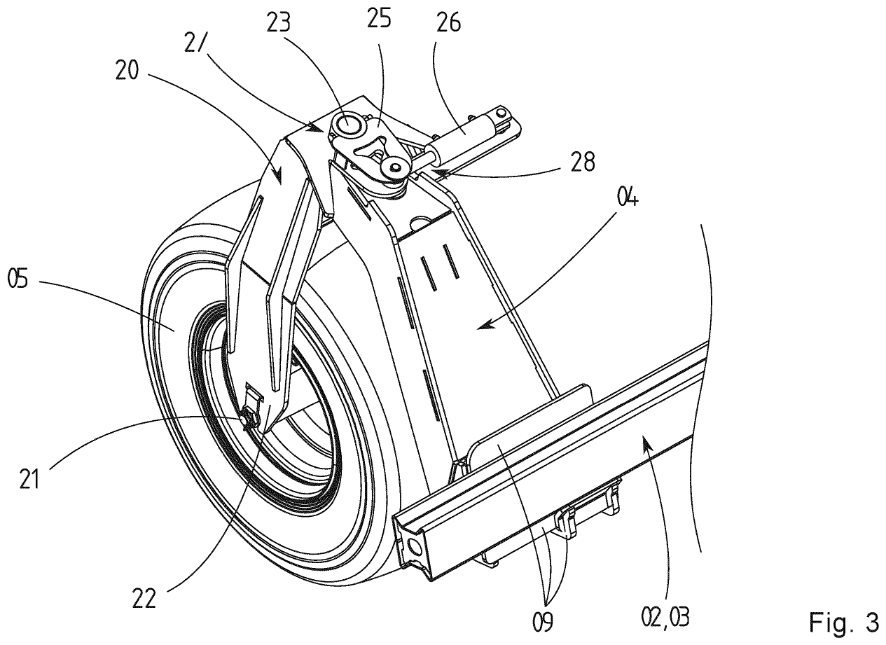

FIG. 1 shows an agricultural work implement 10. The work implement is towed by a tractor 11.

The work implement 10 comprises a machine frame 12. The machine frame 12 essentially comprises a drawbar section 13 and a boom or support beam 14. Two running wheels 15 are also provided on the drawbar section 12. These serve to support the drawbar section 13 on the ground.

### DETAILED DESCRIPTION

The support beam 14 serves to hold one or more corresponding units for soil cultivation. In the present case, the work implement 10 is a seed drill. Accordingly, a sowing unit 16 is shown here as an example. This sowing unit 16 is attached to the support beam 14 in the usual manner.

Clamping devices or screw connections can be used for this purpose, for example, or alternatively permanent connections. Several of these sowing units 16 can be attached next to each other on the support beam 14. This serves to place seed in corresponding rows on or in the ground.

In addition, two support wheels 17 are attached to the support beam 14. A support wheel frame 18 is used for this purpose in each case. The support wheel frame 18 is mounted on the support beam 14 of the work implement 10 by means of a coupling element 19. For easier replacement, for example in the event of defects, this coupling element 19 can be detachably connected to the support beam 14. Alternatively, the coupling element 19 can also be permanently connected to the support beam 14, for example to save costs.

A pivot bearing 20 for a support wheel rocker 21 is provided at the free end of the support wheel frame 18. For this purpose, the support wheel frame 18 extends obliquely pointing upwards from the support beam 14. This provides space for the support wheel 17 and the support wheel rocker 21 below the support wheel frame 18. The support wheel 17 and the support wheel rocker 21 are thus arranged rotatably below the support wheel frame 18 and the pivot bearing 20.

The support wheel rocker 21 is usually configured as a U-shaped element. Accordingly, it has two booms 22 pointing downwards here. Between the two free ends of the booms 22 of the support wheel rocker 21 pointing towards the ground runs a horizontal rotation axis 23 for the support wheel 17. The axis of rotation 23 serves to support the support wheel 17 so that it can rotate about its own axis.

If necessary, the rotation axis 23 can be provided with corresponding bearings, in particular smooth-running bearings, such as ball bearings or the like.

In order to pivotably mount the support wheel rocker 21 and thus the support wheel 17 on the support wheel frame 19, the pivot bearing 20 has a pivot axis 24. The pivot axis 24 extends here in an essentially vertical direction, thus practically perpendicular to the ground in the working position of the work implement 10. The support wheel 17 is thus mounted with the support wheel rocker 21 on the support wheel frame 18 about the vertical pivot axis 24.

A drive unit 25 is also provided here to ensure the functionality according to the disclosure. In the example according to the disclosure, the drive unit 25 has the actual drive 26, which may, for example, be a hydraulic cylinder, a motor, a pneumatic cylinder or the like. In this case, a hydraulic cylinder is provided as drive 26. In addition, an eccentric 27 is attached to the pivot axis 24. This serves to enable the hydraulic drive 26 to exert a torque on the pivot axis 24. Alternatively, an electric motor drive, for example, can be used here in a simple manner.

On the one hand, the pivot axis 24 is rotatably mounted in the support wheel frame 19. On the other hand, it is firmly connected to the support wheel rocker 21. Therefore, a rotation of the pivot axis 24 results in the support wheel rocker 21 being pivotably mounted relative to the support wheel frame 19 and thus the work implement 10.

The method is roughly outlined below:

Depending on the direction of travel of the work implement 10 or the tractor 11 pulling it, the position of the support wheel 17 relative to the work implement 10 can now be set. In this process, the drive unit 25 is used to set the direction of travel of the support wheel 17 accordingly. In this way, it can be achieved that the support wheel 17 rolls over the ground according to the current direction of movement instead of being pushed sideways over the soil, for example.

The drive unit 25 is operated accordingly by a control system not shown here. The control system can, for example, be provided in the work implement 10 or in the tractor 11, or if necessary in combination at both points. It is used to record corresponding measurement data and set the position of the support wheels 17 accordingly.

As a basis for determining the pivot angle to be set, data such as the current direction of movement of the work implement 10 can be used, for example. This can also be determined in comparison to the movement of the tractor 11, for example by determining an angle between the two directions of movement of the tractor 11 and the work implement 10. Data such as the steering wheel position of the tractor 11 can also be included. Other data, such as GPS data, map data or other aspects, such as border strips or the condition of the ground, can be included in the calculation.

Accordingly, the work implement 10 can also have its own sensors, in particular position detection sensors, such as GPS sensors, distance sensors or motion sensors in general. The corresponding sensors can naturally also be arranged on a tractor 11 in addition to or instead of the work implement 10.

Based on selected or all alignment data, position data, movement data and any other measured values, a forecast can then be calculated for the current or planned movement of the work implement 10 in the near future. This allows the support wheels 17 to be pivoted accordingly in the direction of movement. For this purpose, the corresponding pivot angle can be set using the drive units 15.

If necessary, the control system can also be extended to form a closed-loop control system. In particular, the control system can also have a single closed-loop control unit. The current position or alignment of the support wheel can be detected in order to compare it with the desired setting and to regulate the actual alignment if necessary.

In order to detect the actual position, appropriate sensors, such as angle sensors or other measuring devices, are used. These are used to detect the current position of the support wheels 17. By then comparing the predicted setting of the support wheels 17 with the actual position, control can take place. In this way, it can then be ensured that the respective support wheel 17 optimally follows the intended position.

### REFERENCE SIGNS

10 work implement
11 tractor
12 machine frame
13 drawbar section
14 support beam
15 running wheels
16 sowing unit
17 support wheel
18 support wheel frame
19 coupling element
20 pivot bearing
21 support wheel rocker
22 boom
23 rotation axis
24 pivot axis
25 drive unit
26 drive
27 eccentric

1. Method for operating a towed agricultural work implement with a boom, in particular a seed drill or cultivator, with at least one support wheel for supporting the boom on a ground, characterized in that the at least one support wheel is actively controlled.

2. Method according to claim 1, characterized in that at least one axis of the at least one support wheel is driven, preferably a rotation axis and/or a pivot axis and/or a tilting axis.

3. Method according to claim 1, characterized in that at least one drive unit, preferably a motor drive, is assigned to the at least one support wheel, preferably to at least one or each of the axes of the support wheel, in particular one output drive being provided for each axis.

4. Method according to one of the preceding claims, characterized in that the alignment and/or the position and/or height of the at least one support wheel is set relative to the work implement, wherein the support wheel is preferably pivoted about a pivot axis, in particular a vertical pivot axis, in particular for adaptation to the movement of the work implement relative to the ground.

5. Method according to one of the preceding claims, characterized in that the at least one support wheel is rotationally driven and/or in that the rotational speed of the at least one support wheel is controlled about its rotational axis, in particular in each case for adaptation to the movement relative to the ground.

6. Method according to one of the preceding claims, characterized in that the at least one axis of the support wheel, preferably each of the axes, is driven by means of a motor drive.

7. Method according to claim 1, characterized in that the at least one support wheel is steered and/or driven by a motor, wherein in particular at least one control unit is provided for controlling the drive.

8. Method according to one of the preceding claims, characterized in that the current movement state of the work implement and/or a tractor for the drive of the at least one axis of the support wheel is/are taken into account and/or wherein past movements and/or movements predicted for the future are taken into account, in particular curve radii, wherein, in particular, the further course of travel on the basis of typical courses of travel and/or on the basis of position data (GPS) and/or by means of at least one sensor is/are predicted, wherein preferably movement states to be expected in the future and/or suitable positions of the at least one support wheel are predicted.

9. Towed agricultural work implement with a boom, in particular a seed drill or cultivator, with at least one support wheel for support on a ground, characterized in that an active control of the at least one support wheel is provided.

10. Towed agricultural work implement according to claim 8, characterized in that the support wheel and/or its connection to the boom comprises at least one driven axis, preferably a rotation axis and/or a pivot axis and/or a tilting axis.

11. Towed agricultural work implement according to claim 9 or 10, characterized in that at least one motor drive is provided for the at least one axis, in particular an electric motor and/or pneumatic and/or hydraulic drive and/or in that at least one motor drive for aligning and/or rotating the support wheel is/are provided.

12. Towed agricultural work implement according to one of claims 9 to 11, characterized in that a control system is provided for motor-driving the at least one axis of the support wheel, wherein preferably sensors are provided for determining the current state of movement and/or for predicting states of movement to be expected in the future and/or wherein in particular the current curve radius and/or the curve radius to be expected in the future is determined, which preferably results in the suitable position of the at least one support wheel.

13. Towed agricultural work implement according to one of claims 9 to 12, characterized in that sensors are provided for determining the actual position of the at least one support wheel, preferably in order to be able to regulate the actual position of the at least one support wheel.

14. Towed agricultural work implement according to one of claims 9 to 13, characterized in that control signals are determined on the basis of movement data of a towing vehicle and/or in that a coupling of the control system of the at least one support wheel with a control system of a towing vehicle is provided.

15. Towed agricultural work implement according to one of claims 9 to 14, characterized in that an in particular motorized height adjustment of the at least one support wheel is provided.
